(19) United States
(12) Patent Application Publication
(10) Pub. No.: US 2026/0039459 A1
(43) Pub. Date: Feb. 5, 2026

(54) SYSTEMS AND METHODS FOR AI/ML-BASED CRYPTOGRAPHY ANALYSIS AND REMEDIATION USING HYBRID CRYPTOGRAPHY TECHNIQUES

(71) Applicant: Verizon Patent and Licensing Inc., Basking Ridge, NJ (US)

(72) Inventors: Said Soulhi, Saint Cloud, FL (US); Yousif Targali, Sammamish, WA (US); Stuart Wilson, York (GB)

(73) Assignee: Verizon Patent and Licensing Inc., Basking Ridge, NJ (US)

(21) Appl. No.: 18/822,579

(22) Filed: Sep. 3, 2024

Related U.S. Application Data
(63) Continuation-in-part of application No. 18/790,559, filed on Jul. 31, 2024.

(51) Int. Cl. H04L 9/08; H04L 9/14

(52) U.S. Cl. CPC H04L 9/0861; H04L 9/14

(57) ABSTRACT

A device described herein may maintain a set of models that include a plurality of cryptography configurations. A particular cryptography configuration may specify a first cryptography technique, a second cryptography technique, and a combination scheme. The device may provide the particular cryptography configuration to a particular system. The particular system may generate a first key based on the first cryptography technique, generate a second key based on the second cryptography technique, and generate a third key based on the first key, the second key, and the combination scheme. The third key may be used to encrypt communications associated with the particular system, such as by using the third key as a symmetric key.

### BACKGROUND

This application is a Continuation-in-part of U.S. patent application Ser. No. 18/790,559, filed on Jul. 31, 2024, titled “SYSTEMS AND METHODS FOR AUML-BASED CRYPTOGRAPHY ANALYSIS AND REMEDIATION USING HYBRID CRYPTOGRAPHY TECHNIQUES,” the contents of which are herein incorporated by reference in their entirety.

### BACKGROUND

Networks provide for connectivity between different types of devices, such as application servers, client devices, cloud systems, etc. Cryptographic techniques may be used to secure access to such devices, communications between such devices, and/or to otherwise protect the networks and/or devices that communicate via networks. The cryptographic techniques may include encryption techniques, key-based authentication techniques, or the like. Some cryptographic techniques may be more resilient or “hack-proof” than others. Additionally, some cryptographic techniques may have less stringent hardware or processing requirements than others. Additionally, modifying or migrating cryptography configurations promptly and without impact to surrounding infrastructure may be difficult or laborious due to factors such as non-standardized configurations, cryptographic algorithm or protocol support, lack of automated configuration techniques, etc.

### BRIEF DESCRIPTION OF THE DRAWINGS

FIG. 1 illustrates an example overview of one or more embodiments described herein;

FIG. 2 illustrates an example process for utilizing automated techniques to refine the cryptography techniques employed by a system, such as a wireless network, in accordance with some embodiments;

FIG. 3 illustrates an example of cryptography configurations, in accordance with some embodiments;

FIG. 4 illustrates an example of a hybrid key, in accordance with some embodiments;

FIGS. 5-10 illustrate examples of generating and/or utilizing a hybrid key, in accordance with some embodiments;

FIGS. 11 and 12 illustrate an example environment in which one or more embodiments, described herein, may be implemented;

FIG. 13 illustrates an example arrangement of a radio access network (“RAN”), in accordance with some embodiments; and

FIG. 14 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

Embodiments described herein provide for securing of communication networks via the automated collection, analysis, and refinement of cryptographic techniques used in the networks. For example, as discussed below, artificial intelligence/machine learning (“AI/ML”) techniques or other suitable automated techniques may be employed in order to identify or classify cryptography techniques utilized by networks or systems, to identify possible attack vectors to which such cryptographic techniques may be vulnerable, relationships or dependences of such cryptographic techniques, or the like. A cryptographic ontology of a given system (e.g., a network, device, or group of devices) may accordingly be generated, where such ontology represents types, properties, interrelationships, etc. of cryptographic techniques used by the system. Additionally, capabilities of the system may be determined, such as hardware capabilities (e.g., quantity of processors, memory capacity, storage space, quantum computing capability, etc.). Furthermore, other aspects of the system may be determined, such as Quality of Service (“QoS”) requirements, Service Level Agreements (“SLAs”), performance thresholds, etc.

In accordance with some embodiments, the cryptographic ontology and of a given system may be analyzed using AI/ML techniques or other automated techniques, in order to identify potential configuration modifications to the system, including modifications to cryptographic techniques used by the system (e.g., updates to the cryptographic techniques, different cryptographic techniques, modifications to parameters of the crypto techniques such as higher bit encryption techniques, etc.). Determining the modifications based on the capabilities of the system may ensure that the modifications are compatible with the system (e.g., do not exceed the capabilities of the system). Additionally, determining the modifications based on QoS requirements, SLAs, etc. of the system may ensure that the performance the system is not negatively impacted or degraded when implementing such modifications. In this manner, the cryptographic techniques used by the system, and accordingly the security of the system, may be optimized in an automated manner.

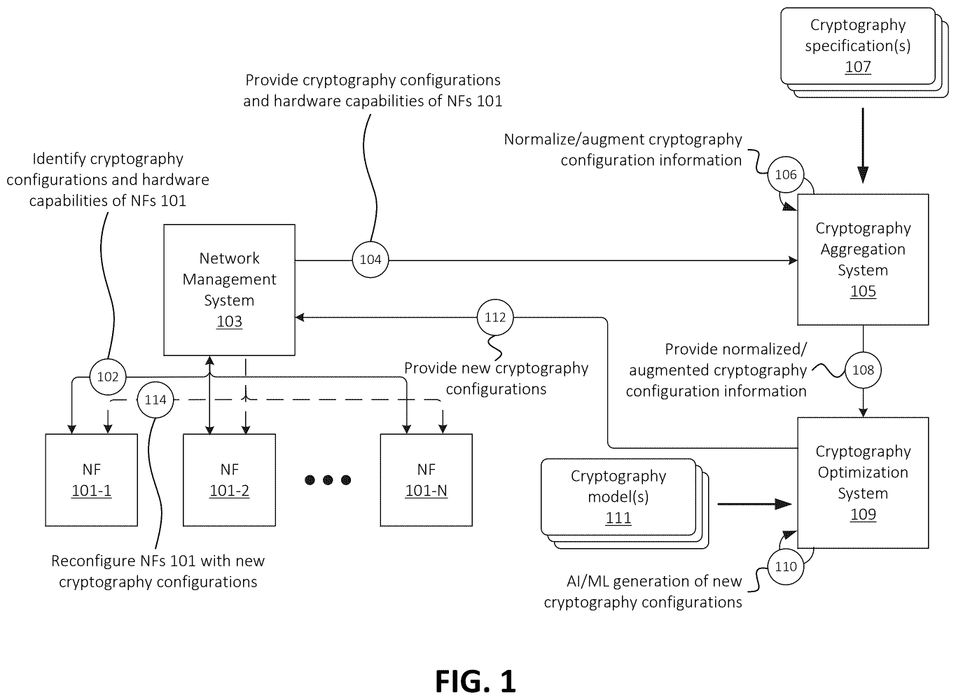

As shown in FIG. 1, for example, a set of devices (e.g., Network Functions (“NFs”) 101 such as NFs 101-1, 101-2, and 101-N), may be communicatively coupled to Network Management System (“NMS”) 103. As discussed below, NFs 101 may include different types of NFs that each perform respective operations that facilitate the wireless network to provide connectivity between devices (e.g., User Equipment (“UEs”), server devices, or the like) and/or other networks. Such operations may include, for example, managing access to the network, establishing and/or enforcing QoS policies and/or SLAs, routing user plane traffic, providing location services, etc. While discussed in the context of a wireless network that includes NFs 101 and NMS 103, embodiments described herein may be implemented in different kinds of networks and/or with different types of devices or systems.

NMS 103 may perform operations such as configuring NFs 101, instantiating and/or de-instantiating NFs 101 (e.g., in environments where NFs 101 are implemented in a virtualized and/or a containerized manner), monitoring Key Performance Indicators (“KPIs”) or metrics associated with NFs 101, or the like. In some implementations, NMS 103 and/or NFs 101 may implement cryptography techniques in order to secure access to NFs 101, to authenticate NFs 101 and/or NMS 103, to secure communications between NFs 101 and/or NMS 103, and/or to otherwise provide security to the network that includes NFs 101 and NMS 103.

Securing access to a given NF 101 may include, for example, verifying that an entity attempting to access a given NF 101 is authorized to access the given NF 101. For example, NMS 103 and NF 101 may participate in a cryptographic authentication technique, such as a key exchange technique (e.g., a Diffie-Hellman key exchange technique, a Public Key Infrastructure (“PKI”) technique, a Key Escrow Server (“KES”)-based technique, or the like), an authentication token-based technique, and/or some other suitable authentication technique that employs cryptographic operations.

Authenticating communications between NFs 101 and/or NMS 103 may include using cryptographic techniques, such as cryptographic keys, authentication tokens, etc., to verify that communications received from a given NF 101 are in fact from the given NF 101 as opposed to from some other source. Securing communications between NFs 101 and/or NMS 103 may include utilizing cryptographic encryption techniques, such as a Secure Hashing Algorithm (“SHA”) encryption technique, a Secure Sockets Layer (“SSL”) encryption technique, an Advanced Encryption Standard (“AES”) encryption technique, etc.

Each NF 101 may be configured with particular application programming interfaces (“APIs”), software development kits (“SDKs”), libraries, firmware, etc., which may be associated with implementing cryptographic security techniques for authentication, authorization, encryption, etc. For example, NMS 103 may configure each NF 101, and/or some other suitable device or system may configure each NF 101, with such APIs, SDKs, libraries, etc.

As shown, NMS 103 may identify (at 102) cryptography configurations and hardware capabilities of NFs 101. For example, as noted above, NMS 103 may perform operations to configure some or all NFs 101 with particular cryptography configurations, such as installing, updating, instantiating, deploying, etc. particular APIs, SDKs, firmware, keys, tokens, encryption algorithms, etc. on NFs 101. Additionally, or alternatively, NMS 103 may communicate with some or all NFs 101 to identify APIs, SDKs, firmware, keys, tokens, encryption algorithms, etc. that have been installed on, instantiated on, implemented by, etc. some or all NFs 101.

NMS 103 may further identify hardware capabilities, configurations, etc. of NFs 101. For example, NMS 103 may identify types of hardware resources (e.g., “bare metal” machines, virtual machines, cloud systems, etc.) that implement particular NFs 101, hardware resource monitoring parameters such as available or used storage space, available or used memory, available or used network bandwidth, or the like. Additionally, NMS 103 may identify hardware resource parameters such as quantity or type of processors of devices that implement NFs 101, types or amounts of memory or storage space of devices that implement NFs 101, or the like. Similarly noted above, in some embodiments, NMS 103 may identify QoS policies, SLAs, performance thresholds, etc. (referred to simply as “QoS parameters” for the sake of brevity) associated with some or all NFs 101. In this manner, NMS 103 may identify (at 102) cryptography configurations, hardware capabilities, and/or QoS parameters of some or all NFs 101 of a wireless network. In some embodiments, NMS 103 may monitor some or all NFs 101 in real time or near-real time (e.g., on an ongoing basis) in order to maintain up-to-date cryptography configuration information associated with some or all NFs 101.

NMS 103 may provide (at 104) information to Cryptography Aggregation System (“CAS”) 105, indicating the cryptography configurations and/or the hardware capabilities of some NFs 101. In some embodiments, CAS 105 may further receive, maintain, etc. one or more cryptography specifications 107. Cryptography specifications 107 may, for example, include parameters, conditions, attributes, markers, flags, etc. associated with various cryptography techniques. CAS 105 may, for example, compare cryptography configuration information received from NMS 103 (e.g., cryptography configuration information associated with a particular NF 101) to one or more cryptography specifications 107, to determine a particular matching cryptography specification 107. For example, NMS 103 may provide (at 104) the cryptography configuration information in a non-standardized or an unstructured manner, and CAS 105 may utilize AI/ML techniques, similarity analysis techniques, or other suitable techniques in order to correlate cryptography configuration information, received from NMS 103 and associated with the particular NF 101, with a particular cryptography specification 107. The particular cryptography specification 107 may include, for example, a name, a version number, a classification, and/or one or more other parameters associated with one or more particular cryptography techniques. In this sense, NMS 103 (and/or other devices or systems with which CAS 105 communicates in a similar manner) does not need to format the cryptography configuration information for any given NF 101, prior to outputting the cryptography configuration information to CAS 105. That is, CAS 105 may be “plug and play” with respect to any suitable type of device or system that provides cryptography configuration information in a non-standardized and/or unstructured format.

CAS 105 may, in some embodiments, normalize and/or augment (at 106) the cryptography configuration info, received from NMS 103, based on cryptography specifications 107. For example, CAS 105 may add tags or labels, reformat some or all of the received cryptography configuration information, etc. based on an identified (e.g., matching) cryptography specification 107. In this sense, although the cryptography configuration information received from NMS 103 may be unstructured or in a non-standard format, structured and/or normalized cryptography information may be produced (e.g., as derived from or included in a matching cryptography specification 107) that represents the cryptography configuration of some or all NFs 101. The structured and/or normalized cryptography information, generated by CAS 105, may include tags, labels, etc., such as the name or version of a given API, SDK, cryptography technique, etc. employed by some or all NFs 101.

In some embodiments, CAS 105 may identify further attributes of cryptography configurations implemented by some or all NFs 101. For example, CAS 105 may identify dependencies, constraints, etc. associated with such cryptography configurations. Dependencies may include cryptography techniques used to secure communication pathways between different NFs 101, such as a particular set of keys, tokens, etc. that are used for securing communications between two or more different NFs 101. In some scenarios, dependencies or constraints may include information indicating such communication pathways themselves, such as network interfaces, Service-Based Interface (“SBIs”), or the like. In some embodiments, identifying a dependency or constraint may include identifying authentication keys, certificates, etc. that are used by specific NFs 101 or types of NFs 101 (e.g., where the presence of a given key, certificate, etc. signifies that a particular NF 101 may use such key, certificate, etc. to securely communicate with another particular NF 101).

As noted above, different types of devices or systems may communicate with CAS 105 via a unified interface, API, etc. implemented by CAS 105, via which such different types of devices or systems may provide differently formatted, unstructured cryptography configuration information, without the need to implement a mechanism by which such configuration information is formatted or normalized into a unified and portable ontology. That is, CAS 105 may generate a cryptographic ontology associated with NMS 103 and/or one or more NFs 101, and may similarly generate cryptographic ontologies for multiple systems that provide cryptography information in diverse or unstructured formats.

In some embodiments, the cryptography ontology for a given system (e.g., for NMS 103 and/or some or all NFs 101) may include the normalized and/or augmented cryptography information (e.g., as generated or determined by CAS 105). In some embodiments, the cryptography ontology for the given system may further include hardware capability information, QoS parameters, and/or other suitable information associated with some or all elements of the system (e.g., hardware capability information and/or QoS parameters associated with one or more NFs 101 and/or of NMS 103).

CAS 105 may, in some embodiments, provide (at 108) the normalized and/or augmented cryptography information to Cryptography Optimization System (“COS”) 109. For example, in some embodiments, COS 109 may receive the cryptography ontology, including hardware capabilities of NFs 101 and/or NMS 103. COS 109 may also receive, maintain, refine, etc. one or more cryptography models 111. In some embodiments, cryptography models 111 may include values, variables, categories, etc. that are in a same format as the ontology as generated by CAS 105. In this sense, in some embodiments, the normalizing and/or augmentation (e.g., generation of the cryptography ontology) may include reformatting or otherwise augmenting the cryptography configuration information, received from NMS 103, into a format that is compatible with one or more cryptography models 111.

Cryptography models 111 may include, in some embodiments, cryptography configurations that have been optimized for factors such as increased security, reduced resource consumption (e.g., reduced processor consumption, reduced memory consumption, reduced network bandwidth consumption, etc.), compliance with regulations or information technology (“IT”) policies, etc. For example, COS 109 and/or some other suitable device or system may utilize AI/ML techniques or other suitable techniques to automatically refine different cryptography configurations (e.g., hundreds, thousands, millions, etc. of cryptography configurations) that have been determined as being optimal for one or more factors. In some embodiments, for example, a first set of cryptography models 111 may be optimized for increased security (e.g., reduced risk of attack or malicious access), a second set of cryptography models 111 may be optimized for reduced resource consumption, a third set of cryptography models 111 may be optimized for a blend of increased security and reduced resource consumption, and so on.

In some embodiments, each cryptography model 111 may include a score, value, indicator, etc. of such optimization factors. For example, a first cryptography model 111 (e.g., a first set of cryptography configurations) may include a relative high score for security (e.g., increased difficulty to “hack” or “crack,” reduced risk of attack or malicious access, etc.) and a relative low score for resource consumption and/or performance (e.g., cryptography configurations indicated in such cryptography model 111 may be relatively time-consuming or resource-intensive to implement). As another example, a second cryptography model 111 may include a relatively lower score for security and a relatively higher score for resource consumption and/or performance.

In some embodiments, COS 109 may perform one or more training operations in order to generate one or more cryptography models 111 (e.g., in order to associate particular sets input cryptography configurations with particular respective sets of output cryptography configurations, to score or classify such cryptography models 111, etc.). COS 109 may, for example, perform simulations of different cryptography configurations to determine measures of security, resource consumption, or other factors or metrics. In some embodiments, the simulations may be performed on different types of hardware resources with different hardware capabilities, and/or such different hardware capabilities may be simulated as well. Additionally, or alternatively, COS 109 may perform one or more other types of training operations, such as supervised learning, unsupervised learning, etc.

In some embodiments, a given cryptography model 111 may include a set of inputs and a set of outputs. The set of inputs may be specified in terms of conditions, criteria, etc., which COS 109 may compare to a given cryptography ontology (e.g., as provided by CAS 105) associated with a given system (e.g., NMS 103 and/or NFs 101). The set of outputs may include a modified or different set of cryptography configuration information (e.g., a different cryptography ontology) that is more optimal than a current cryptography ontology in one or more respects (e.g., increased security, reduced resource consumption, etc.).

Cryptography models 111 may accordingly correlate respective sets of outputs (e.g., remediation actions such as modifying cryptography techniques such as the use of particular algorithms or cryptography techniques, modifying cryptography parameters such as quantity of bits used for encryption, or the like) with respective sets of inputs (e.g., current cryptography configurations of NFs 101 and/or NMS 103). COS 109 may utilize AI/ML techniques such as neural networks, K-means clustering, and/or other suitable AI/ML techniques to determine the correlations between particular sets of outputs and particular sets of inputs. In this manner, COS 109 may be able to identify or generate (at 110) a particular cryptography model 111 and/or a particular set of outputs (e.g., a modified or new cryptography configuration) to apply when given a particular set of inputs (e.g., a current cryptography ontology of a system that includes NMS 103 and/or NFs 101, and/or a current cryptography configuration of NMS 103 and/or one or more NFs 101). In accordance with some embodiments described herein, and as further discussed below, one or more of the cryptography configurations may include utilizing multiple cryptography techniques, such as multiple cryptographic algorithms, keys, or the like, to secure communications between respective NFs 101.

In some embodiments, COS 109 may perform a similarity analysis to associate a particular cryptography ontology (e.g., a cryptography configuration of NMS 103 and/or one or more NFs 101) with a particular set of inputs of one or more cryptography models 111. For example, COS 109 may perform such analysis in order to identify a particular model 111, and/or a set of inputs of one or more models 111, that “match” the current cryptography ontology. The “match” may include an exact match, and/or may include “closest” match (e.g., where the similarity analysis yields a particular model 111 or set of inputs of one or more models 111 that are associated with a highest measure of similarity in accordance with the similarity analysis).

In some embodiments, a particular input may be associated with multiple different outputs, with differing weights applied to reflect different sets of hardware resources that may be implemented. For example, one set of output cryptography configurations may be associated with a given input cryptography configuration with a first set of hardware capabilities, while a second set of output cryptography configurations may be associated with the same given input cryptography configuration with a different second set of hardware capabilities. That is, for example, a first set of hardware resources that includes the first set of hardware capabilities may be a better fit for the first set of output cryptography configurations, while a second set of hardware resources that includes the second set of hardware capabilities may be a better fit for the second set of output cryptography configurations. In one scenario, the second set of output cryptography configurations may have steeper hardware requirements (e.g., may be more processor-intensive, may be more memory-intensive, etc.), and may not be feasible to ultimately implement on lesser hardware (e.g., the first set of hardware resources in this example).

COS 109 may provide (at 112) the newly identified or generated cryptography configurations to NMS 103. For example, COS 109 may communicate with NMS 103 via an API or some other suitable communication pathway. Additionally, or alternatively, COS 109 may provide (at 112) the new cryptography configurations to CAS 105, which may in turn provide such cryptography configurations to NMS 103 (e.g., via the same communication pathway used by NMS 103 and CAS 105 to communicate with each other at 104).

NMS 103 may accordingly implement (at 114) the reconfiguration of NMS 103 and/or NFs 101 based on the provided cryptography configurations. For example, as noted above, the new cryptography configurations may include different versions (e.g., updated versions) of libraries, applications, operating systems, firmware, etc. implemented by NMS 103 and/or NFs 101. In some implementations, new cryptography configuration may include a set of authentication keys, certificates, etc. NMS 103 may, for example, install, instantiate, etc. such libraries, applications, keys, certificates, etc. at NMS 103 and/or one or more NFs 101. As another example, the new cryptography configurations may include parameters (e.g., quantity of bits used for encryption) that may be provided to NFs 101, where NFs 101 may implement updated cryptography configurations by updating such parameters. In some embodiments, the new cryptography configurations may include one or more other types of updates, configurations, etc. that may be used to implement enhanced cryptography techniques to secure access to NFs 101, to secure communications between NFs 101, and/or to otherwise increase the security of the system that includes NMS 103 and NFs 101.

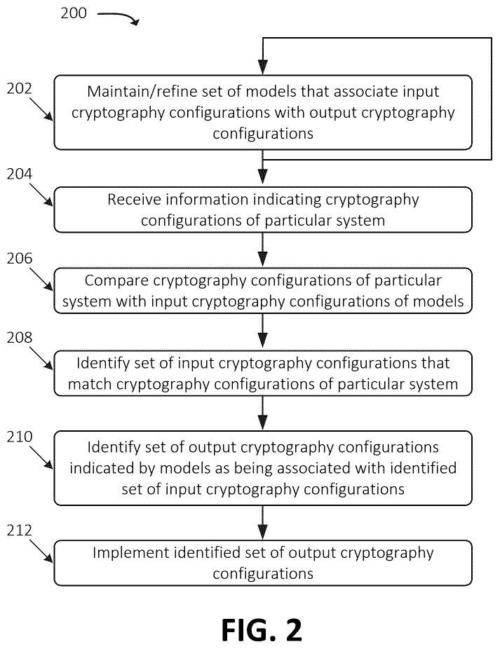

FIG. 2 illustrates an example process 200 for utilizing automated techniques to refine the cryptography techniques employed by a system, such as a wireless network. In some embodiments, some or all of process 200 may be performed by COS 109. In some embodiments, one or more other devices may perform some or all of process 200 in concert with, and/or in lieu of, COS 109, such as CAS 105.

As shown, process 200 may include maintaining and/or refining (at 202) a set of models that associate respective sets of cryptography configurations (e.g., sets of input cryptography configurations) with respective sets of improved or modified cryptography configurations (e.g., sets of output cryptography configurations). As noted above, the input and/or output sets of cryptography configurations of one or more cryptography models 111 may each include information defining cryptography techniques (e.g., encryption techniques, authentication techniques, etc., and/or parameters of such cryptography techniques (e.g., a quantity of bits used for performing cryptography techniques for encryption, key generation, etc.). Additionally, or alternatively, a given cryptography configuration may include information specifying particular APIs, SDKs, firmware, etc. that can be used to implement particular cryptography techniques. In some embodiments, the cryptography configurations may include information specifying hardware requirements, resource requirements, or the like. In some embodiments, the cryptography configurations may include authentication keys, certificates, etc. that are used to communicate with one or more particular devices or systems (e.g., one or more specific NFs 101 and/or types of NFs 101 of a wireless network). As noted above, different sets of output cryptography configurations may be associated with the same set of input cryptography configurations with differing hardware capabilities and/or other factors. In some embodiments, COS 109 may utilize AI/ML techniques to train, refine, etc. such models to optimize factors such as enhanced security, hardware resource utilization, etc.

Process 200 may further include receiving (at 204) information indicating cryptography configurations of a particular system. For example, as discussed above, COS 109 may receive information specifying cryptography configurations, such as information indicating particular cryptography techniques, APIs, SDKs, cryptography parameters, etc. implemented by a given system. In the examples provided above, the cryptography configurations pertain to cryptography techniques implemented by a wireless network that includes NMS 103 and one or more NFs 101. In some embodiments, the cryptography configuration information may further include additional details regarding the system, such as hardware capabilities, quantities of devices, communication pathways between such devices, and so on.

Process 200 may additionally include comparing (at 206) cryptography configurations of the particular system with input cryptography configurations of one or more models. For example, COS 109 may perform a similarity analysis to identify a matching input cryptography configuration, as specified in one or more cryptography models 111, with the configuration of the system (e.g., of NMS 103 and/or one or more NFs 101).

Process 200 may also include identifying (at 208) a set of input cryptography configurations that match the cryptography configurations of the particular system. For example, COS 109 may identify a measure of similarity between the cryptography configurations of the particular system and one or more input cryptography configurations of the cryptography models 111, in order to identify a most closely matching input cryptography configuration as indicated in one or more cryptography models 111.

Process 200 may further include identifying (at 210) a set of output cryptography configurations that are indicated in the models as being associated with the identified set of input cryptography configurations. For example, COS 109 may identify a particular output cryptography configuration (e.g., an optimized, modified, updated, etc. set of cryptography configurations) that is indicated by one or more cryptography models 111 as being associated with the identified set of input cryptography configurations. In some embodiments, COS 109 may further identify the particular output cryptography configuration based on one or more other factors, such as hardware capabilities of the system to be optimized (e.g., hardware capabilities of NMS 103 and/or NFs 101, in the examples discussed above).

In some embodiments, COS 109 may identify the particular output cryptography configuration based on security and/or risk factors, performance and/or resource consumption factors, or the like. For example, a particular NF 101 and/or type of NF 101 may be associated with QoS policies, Service Level Agreements (“SLAs”), performance thresholds, or the like, and COS 109 may identify a particular cryptography model 111 that is associated with a score, indicator, etc. of performance and/or resource consumption commensurate with the QoS policies, SLAs, performance thresholds, etc. associated with NF 101. For example, if NF 101 is associated with relatively stringent QoS parameters (e.g., relatively high throughput thresholds, relatively low latency thresholds, etc.), COS 109 may identify a particular cryptography model 111 that optimizes QoS parameters (e.g., is associated with a relatively high score for performance). In a similar manner, COS 109 may identify cryptography models 111 that optimize different factors for different NFs 101 (e.g., where such factors may be indicated in the cryptography ontology for such NFs 101, may be specified as part of a request for a new cryptography configuration for one or more NFs 101, and/or may otherwise be determined by COS 109). In this manner, COS 109 may automatically identify an optimized set of cryptography configurations to implement at the system, which meets the goals, constraints, policies, etc. of the system.

As noted above, and as discussed in more detail below, an identified output cryptography configuration may include multiple cryptography techniques, such as multiple cryptography techniques or algorithms, multiple sets of keys, multiple different key exchange and/or key encapsulation techniques, or the like. A cryptography configuration that utilizes multiple cryptography techniques may, for example, be more secure, more “hack” or “crack” resistant, may be less vulnerable to quantum computing-based attacks, or the like.

Process 200 may additionally include implementing (at 212) the identified set of output cryptography configurations. For example, COS 109 may output the optimized set of cryptography configurations, such as to NMS 103, which may include outputting one or more packages, files, images, etc. to NMS 103. Additionally, or alternatively, COS 109 may output one or more links, references, labels, identifiers, etc. based on which NMS 103 may obtain or retrieve packages, files, images, etc. in order to implement the optimized set of cryptography configurations. NMS 103 and/or NFs 101 may accordingly replace or modify their existing cryptography configurations with the new cryptography configurations indicated by COS 109, thus enhancing the security and overall operation of NMS 103 and/or NFs 101. In some scenarios, replacing or modifying an existing cryptography configuration may include installing, maintaining, etc. an updated set of certificates, authentication keys, etc. that are used to communicate with other NFs 101. For example, an updated cryptography configuration may remove a previously maintained key or certificate used to communicate with another NF 101, where such communications would be unauthorized or otherwise violate policies or protocols. As another example, an updated cryptography configuration may add or update a previously maintained key or certificate used to communicate with another NF 101, where such communications are authorized or specified by one or more policies or protocols.

Some or all of process 200 may be repeated in an iterative manner, in order to continue to identify optimal cryptography configurations and to improve the security of the network that implements such cryptography configurations. As discussed below, the cryptography configurations may each utilize multiple different cryptography techniques, which may ultimately provide a higher level of security.

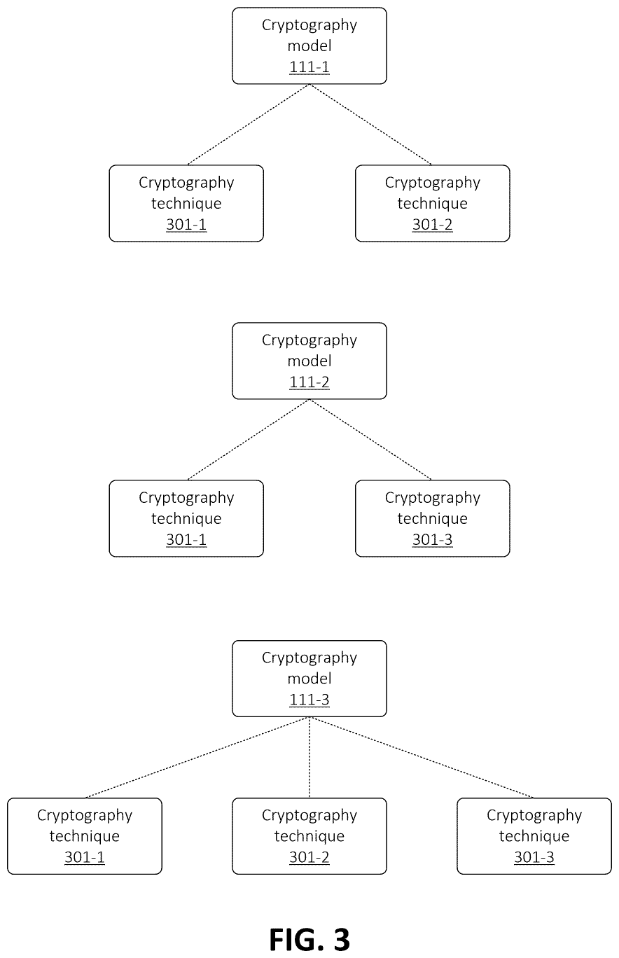

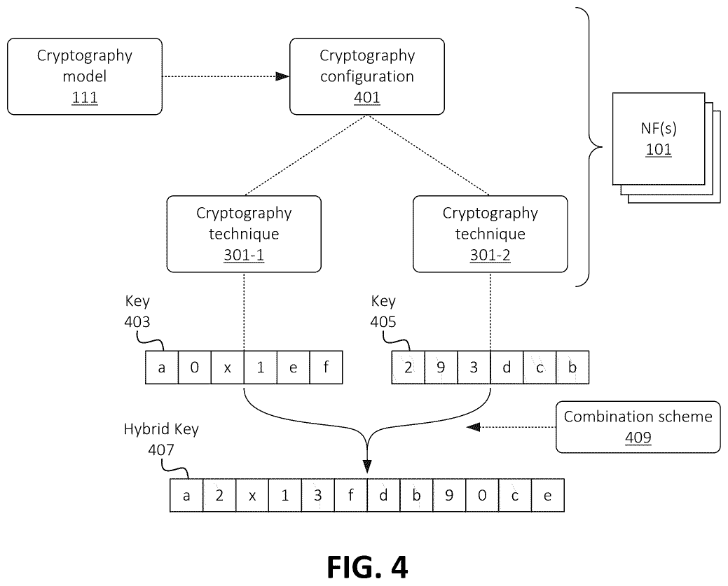

FIG. 3 illustrates an example of different cryptography models 111 that may be used in accordance with some embodiments. For example, example cryptography models 111-1, 111-2, and 111-3 may each specify multiple different cryptography techniques 301. For example, cryptography model 111-1 may specify cryptography techniques 301-1 and 301-2, cryptography model 111-2 may specify cryptography techniques 301-1 and 301-3, and cryptography model 111-3 may specify cryptography techniques 301-1, 301-2, and 301-3. In practice, other cryptography models 111 may specify other quantities of cryptography techniques 301 (e.g., may specify a single cryptography technique 301, or may specify four or more respective cryptography techniques 301). As noted above, each cryptography technique 301 may indicate a specific encryption and/or decryption techniques or algorithms, such as SHA, SSL, AES, or the like. Additionally, or alternatively, cryptography techniques 301 may specify key exchange techniques, which may include KES-based key exchange techniques, Key Encapsulation Mechanism (“KEM”) techniques, or the like. In some embodiments, cryptography techniques 301 may specify particular combination schemes, which may indicate a manner in which different keys, tokens, etc. associated with different encryption techniques or algorithms are to be combined. Examples of different cryptography techniques 301, as specified by different cryptography models 111, are presented below with respect to, for example, FIGS. 4-9.

FIG. 4 illustrates an example of a particular cryptography configuration 401, implemented by one or more NFs 101, based on a particular cryptography model 111. For example, cryptography configuration 401 may be implemented by a particular NF 101, or by a set of NFs 101 (e.g., NFs 101 that are configured to communicate with each other, as determined by NMS 103). In some embodiments, for instance, COS 109 may have determined and provided (e.g., (at 110 and/or 112) cryptography configuration 401 to such NFs 101 (e.g., via NMS 103).

In this example, cryptography model 111 may specify two different cryptography techniques 301-1 and 301-2 (e.g., different cryptographic algorithms, different parameters such as key lengths for one or more cryptographic algorithms, etc.). Accordingly, when implementing cryptography techniques 301-1 and 301-2, a given NF 101 may generate a first key 403 using cryptography technique 301-1, and may generate a second key 405 using cryptography technique 301-2. Although this example shows one key 403 or 405 being generated based on each respective cryptography technique 301, in practice, NF 101 may generate multiple keys based on each respective cryptography technique 301. For example, NF 101 may generate a first key pair (e.g., an asymmetric key pair), which includes key 403, based on the first cryptography technique 301-1 and may generate a second key pair, which includes key 405, based on the second cryptography technique 301-2.

In accordance with some embodiments, NF 101 may further generate hybrid key 407 based on keys 403 and 405. Hybrid key 407 may be considered “hybrid” inasmuch as hybrid key 407 is generated based on keys that were initially generated based on multiple different cryptography techniques 301 (i.e., based on cryptography techniques 301-1 and 301-2, in this example). Further, in some embodiments, hybrid key 407 may be generated in a manner other than simply concatenating or appending keys 403 and 405 together. For example, NF 101 may utilize a particular combination scheme 409 when generating hybrid key 407 based on keys 403 and 405. In some embodiments, combination scheme 409 may include cipher text and/or one or more functions or operations to perform with respect to keys 403 and 405 in order to generate hybrid key 407.

In this example, combination scheme 409 indicates a “scrambling” or interspersing of respective characters of keys 403 and 405 to generate hybrid key 407, including interleaving or interspersing characters from both keys 403 and 405 with each other, and/or modifying (e.g., randomizing or otherwise modifying) the sequence of characters initially included in keys 403 and/or 405.

In this example, keys 403, 405, and 407 are shown as including a particular quantity of characters (e.g., where each character may be represented by a particular quantity of bits, such as 8 bits, 16 bits, 32 bits, etc.). In some circumstances, hybrid key 407 may include all of the characters of key 403 and all of the characters of key 405. In such implementations, the quantity of characters of hybrid key 407 may be equal to the sum of the quantity of characters in key 403 and the quantity of characters in key 405. In some implementations, hybrid key 407 may include more characters than the sum of the respective quantities of characters of keys 403 and 405, while in other implementations hybrid key 407 may include fewer characters than the sum of the respective quantities of characters of keys 403 and 405. For example, certain operations, specified by combination scheme 409, may ultimately dictate the length (e.g., quantity of characters) of hybrid key 407.

In some embodiments, combination scheme 409 may be specified by cryptography model 111. On the other hand, in some embodiments, combination scheme 409 may be specified by a given NF 101, by COS 109 (e.g., independently of determining or generating cryptography model 111), by NMS 103, and/or by some other device or system. In this sense, combination scheme 409 may be “agile” in that even if keys 403 and 405 (and/or cryptography techniques 301-1 and/or 301-2) are not changed for a given NF 101, hybrid key 407 which is ultimately generated based on keys 403 and 405 may be “finetuned” for factors such as increasing security, reducing processing complexity, or the like. Further, modifying combination scheme 409, without reconfiguring NFs 101 to implement different cryptography techniques 301, may allow for a faster and less computationally intensive modification of security mechanisms used to secure NF 101.

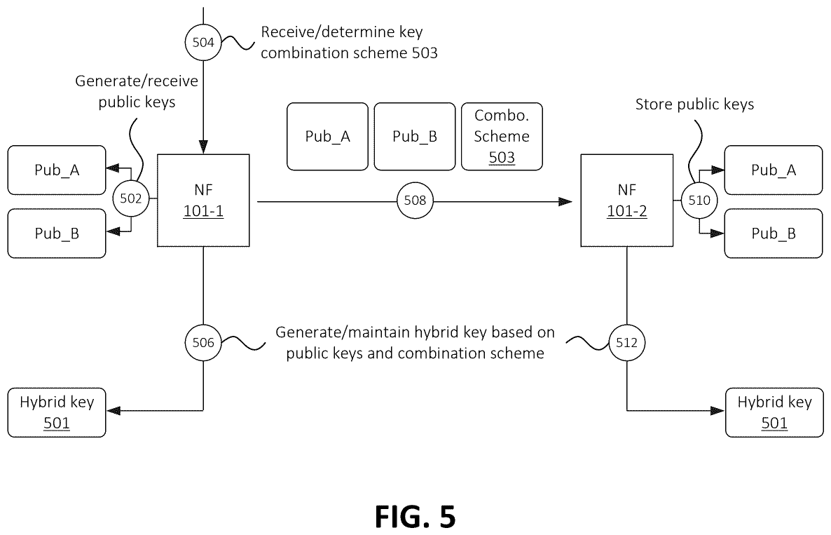

FIG. 5 illustrates an example of the generation of a particular hybrid key 501, which may be used to secure communications between two example NFs 101-1 and 101-2. In this example, NF 101-1 may generate or receive (at 502) a set of keys (“Pub_A” and “Pub_B”). In this example, the keys may be “public” keys or “shared” keys, inasmuch as these keys may be made visible or accessible to other entities (e.g., adversarial entities), without necessarily compromising the security of the techniques described herein. In accordance with embodiments described herein, the two keys may be generated using different cryptography techniques 301. Additionally, or alternatively, in some scenarios, the two keys may be generated using the same cryptography technique 301 multiple times (e.g., a first iteration of implementing a particular cryptography technique may provide Pub_A, while a second iteration of implementing the same particular cryptography technique may provide Pub_B).

NF 101-1 may further receive or determine (at 504) a particular key combination scheme 503. As noted above, combination scheme 503 may be specified by a particular cryptography configuration 401 (e.g., may be indicated by COS 109). In another example, NMS 103 may specify combination scheme 503. In yet another example, NF 101-1 may determine combination scheme 503. NF 101-1 may accordingly generate (at 506) hybrid key 501 based on the multiple keys (e.g., Pub_A and Pub_B, which may be generated based on different cryptography techniques) as well as based on combination scheme 503.

In accordance with some embodiments, NF 101-1 may further provide (at 508) the public keys (e.g., Pub_A and Pub_B) to NF 101-2, as well as combination scheme 503. In some implementations, some or all of this information (e.g., Pub_A, Pub_B, and combination scheme 503) may be provided in an unsecured communication, where an intercepting party may be unaware of how to utilize Pub_A, Pub_B, and combination scheme 503 to generate hybrid key 501. For example, in some embodiments, NFs 101-1 and 101-2 may both implement an API, an SDK, an application, or the like which is not available to external (e.g., unauthorized or malicious) entities, which generates hybrid key 501 based on Pub_A, Pub_B, and combination scheme 503.

While FIG. 5 depicts NF 101-2 receiving Pub_A, Pub_B, and combination scheme 503 from NF 101-1, in some embodiments, NF 101-2 may receive Pub_A, Pub_B, and/or combination scheme 503 from some other device or system, such as NMS 103 (e.g., via a secure communication). Additionally, or alternatively, NF 101-1 may provide (at 508) Pub_A, Pub_B, and/or combination scheme 503 to a KES, from which NF 101-2 may obtain such information. NF 101-2 may accordingly store (at 510) the received keys, and may further use the keys along with combination scheme 503 to generate (at 512) hybrid key 501. In this manner, NFs 101-1 and 101-2 may both have access to the same hybrid key 501.

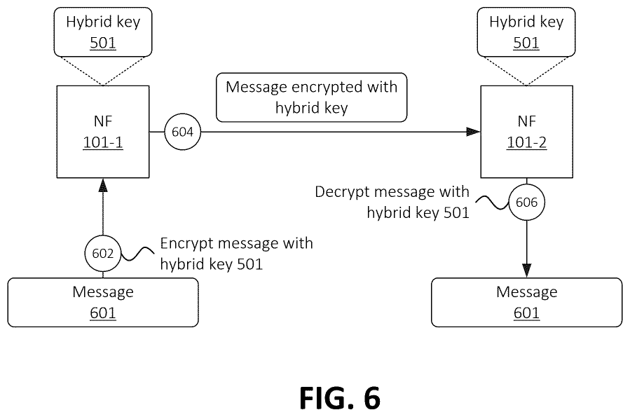

As shown in FIG. 6, NFs 101-1 and 101-2 may use the same hybrid key 501 as a symmetric key to secure communications between NFs 101-1 and 101-2. For example, assume NF 101-1 generates message 601 to be sent to NF 101-2, which may include or may be part of control plane signaling, user plane traffic transmission, or the like. NF 101-1 may encrypt (at 602) message 601 with hybrid key 501, and may output (at 604) the encrypted message to NF 101-2. NF 101-2 may, based on receiving the encrypted message from NF 101-1, identify hybrid key 501 that is associated with communications between NFs 101-1 and 101-2. NF 101-2 may accordingly decrypt (at 606) message 601 using hybrid key 501.

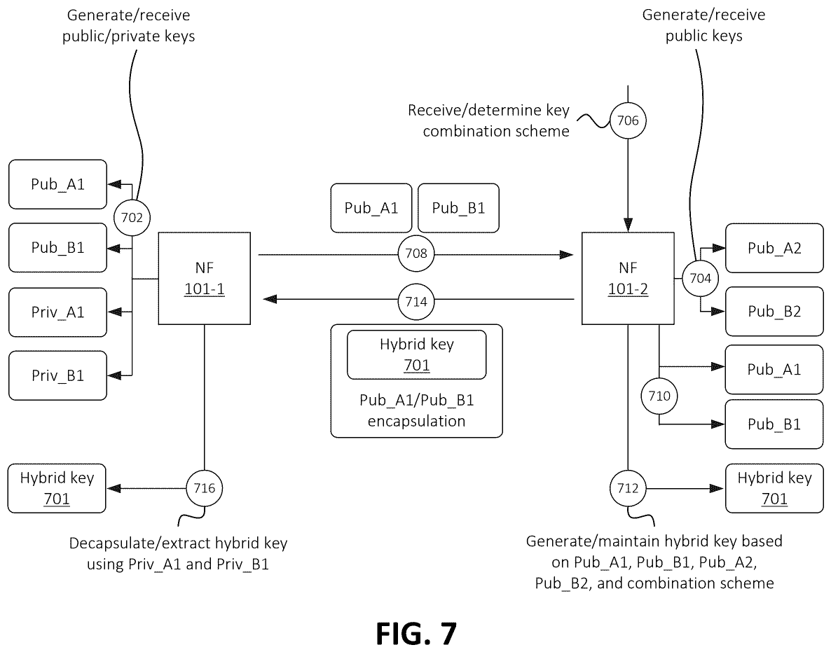

FIG. 7 illustrates another example implementation of generating a hybrid key 701 using multiple cryptography techniques, in accordance with some embodiments. In this example, NF 101-1 may generate or receive (at 702) two sets of keys (e.g., a first set of keys and a second set of keys, such as a first public-private key pair Pub_A1 and Priv_A1, and a second public-private key pair Pub_B1 and Priv_B1). Priv_A1 and Priv_B1 may be “private” inasmuch as NF 101-1 does not share these keys with other entities, including with NF 101-2. In this example, NF 101-2 may also generate or receive (at 704) multiple keys, such as Pub_A2 and Pub_B2. As similarly noted above, in some implementations, Pub_A2 and Pub_B2 may each be public keys in respective public-private key pairs. For purposes of discussing this example, private keys for NF 101-2 are not shown.

As noted above, Pub_A2 and Pub_B2 may generated using different cryptography techniques 301, and/or by multiple iterations of the same cryptography technique 301. In some embodiments, Pub_A2 may be generated using the same cryptography technique as Pub_A1, and/or Pub_B2 may be generated using the same cryptography technique as Pub_B1. In some embodiments, some or all of Pub_A1, Pub_B1, Pub_A2, and/or Pub_B2 may be generated using different cryptography techniques.

NF 101-2 may further receive (at 706) or determine a particular key combination scheme. For example, NF 101-2 may receive the key combination scheme from NMS 103, COS 109, and/or some other suitable device or system. Additionally, or alternatively, NF 101-2 may locally implement operations to determine or generate the key combination scheme. NF 101-2 may further receive (at 708) the public keys (i.e., Pub_A1 and Pub_B1) associated with NF 101-1. As discussed above, NF 101-2 may receive the keys from NF 101-1 (e.g., via a secured or unsecured communication), a KES, or via some other suitable communication pathway. NF 101-2 may maintain (at 710) the public keys associated with NF 101-1, such that NF 101-2 has access to its own public keys (i.e., Pub_A2 and Pub_B2) as well as the public keys for NF 101-1 (i.e., Pub_A1 and Pub_B1).

NF 101-2 may further generate (at 712) hybrid key 701 based on the public keys for NF 101-1, the public keys for NF 101-2, and the combination scheme. In some embodiments, NF 101-2 may generate hybrid key 701 based on fewer than all four keys, such as based on only the public keys for NF 101-2 (i.e., Pub_A2 and Pub_B2), only the public keys for NF 101-1 (i.e., Pub_A1 and Pub_B1), one public key for NF 101-1 and one public key for NF 101-2, and so on.

NF 101-2 may further provide (at 714) the generated hybrid key 701 to NF 101-1. In some embodiments, providing (at 714) hybrid key 701 to NF 101-1 may include utilizing a KEM, in which NF 101-2 utilizes one or more of the keys of NF 101-1 (i.e., Pub_A1 and/or Pub_B1) to encrypt or encapsulate hybrid key 701 (e.g., utilizing one or more KEM techniques). Providing (at 714) the encapsulated hybrid key 701 may further include providing a cipher text or other suitable indication of how Pub_A1 and/or Pub_B1 were used to encapsulate hybrid key 701.

NF 101-1 may decapsulate and/or extract (at 716) hybrid key 701 by using, for example, one or more private keys that correspond to the public keys used by NF 101-2 to encapsulate hybrid key 701. For example, NF 101-1 may utilize cipher text, as provided by NF 101-2, to determine how the public keys of NF 101-1 were used to encapsulate hybrid key 701 and to accordingly utilize the private keys of NF 101-1 to decapsulate hybrid key 701. Once NFs 101-1 and 101-2 have access to hybrid key 701, NFs 101-1 and 101-2 may utilize hybrid key 701 as a symmetric key to encrypt and/or decrypt communications, such as in the example of FIG. 6.

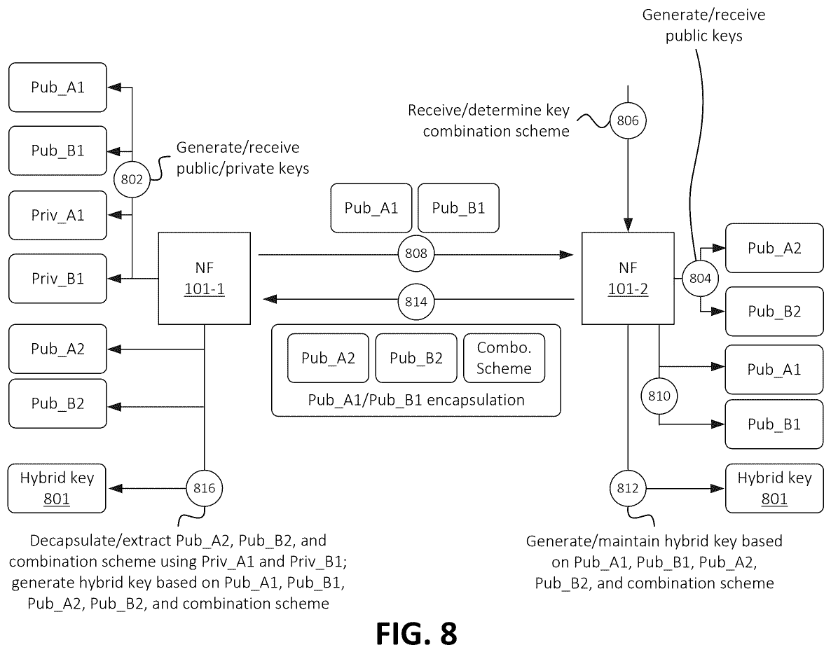

FIG. 8 illustrates another example implementation of generating a hybrid key 801 using multiple cryptography techniques, in accordance with some embodiments. In this example, as similarly discussed above with respect to FIG. 7, NF 101-1 may generate and/or receive (at 802) multiple asymmetric key pairs (e.g., a first key pair that includes Pub_A1 and Priv_A1 and a second key pair that includes Pub_A2 and Priv_A2); NF 101-2 may generate and/or receive (at 804) multiple keys (e.g., public keys Pub_A2 and Pub_B2); NF 101-2 may receive or determine (at 806) a combination scheme that can be used to generate hybrid key 801; NF 101-1 may provide (at 808) its public keys (e.g., Pub_A1 and Pub_B1) to NF 101-2; NF 101-2 may store and/or maintain (at 810) the public keys of NF 101-1; and NF 101-2 may generate and/or maintain (at 812) hybrid key 801 based on some or all of Pub_A1, Pub_B1, Pub_A2, and/or Pub_B2. As similarly noted above, generating hybrid key 801 may be based on a particular combination scheme, which may have been received from another device or system such NMS 103 or COS 109, and/or which may have been determined by NF 101-2.

NF 101-2 may further output (at 814) its public keys (e.g., Pub_A2 and/or Pub_B2) to NF 101-1, as well as the combination scheme used to generate hybrid key 801 based on Pub_A1, Pub_B1, Pub_A2, and/or Pub_B2. In accordance with some embodiments, outputting (at 814) the public keys and the combination scheme to NF 101-1 may include encapsulating one or more messages, that include Pub_A1, Pub_B1, Pub_A2, Pub_B2, and/or the combination scheme, using Pub_A1 and/or Pub_B1. NF 101-1 may decapsulate and/or extract (at 816) the keys of NF 101-2 (e.g., Pub_A2 and Pub_B2) and the combination scheme using the private keys (e.g., Priv_A1 and Priv_B1) of NF 101-1, which may include using one or more KEM techniques.

NF 101-1 may accordingly generate (at 818) hybrid key 801 based on the provided combination scheme. For example, as noted above, the combination scheme may indicate one or more functions, operations, or the like to perform with respect to some or all of Pub_A1, Pub_B1, Pub_A2, and/or Pub_B2 (e.g., the public keys associated with NFs 101-1 and/or 101-2) in order to generate hybrid key 801. As further noted above, NFs 101-1 and 101-2 may utilize hybrid key 801 in order to securely communicate with each other (e.g., may use hybrid key 801 to encrypt and/or decrypt communications between NFs 101-1 and 101-2).

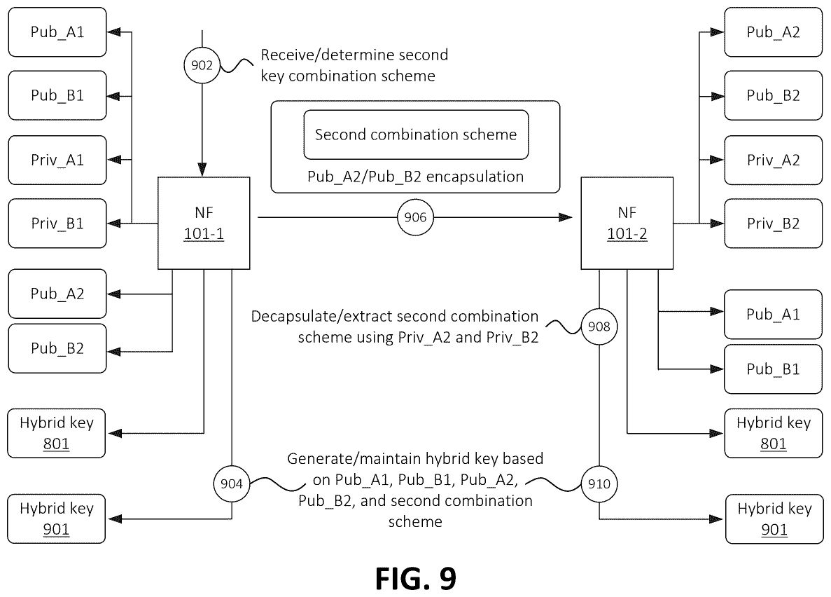

In some embodiments, as shown in FIG. 9, NFs 101-1 and 101-2 may generate multiple hybrid keys (e.g., a first hybrid key 801 and a second hybrid key 901). For example, in addition to generating hybrid key 801 as discussed above with respect to FIG. 8, NF 101-1 may further generate or receive (at 902) a second combination scheme (e.g., which may be different from the combination scheme used to generate hybrid key 801). NF 101-1 may accordingly generate (at 904) the second hybrid key 901 using the combination scheme, which may specify operations, functions, etc. to perform on some or all of Pub_A1, Pub_B1, Pub_A2, and/or Pub_B2 in order to generate hybrid key 901.

NF 101-1 may further provide (at 906) the second combination scheme (and/or may otherwise provide the second hybrid key 901) to NF 101-2. For example, in some embodiments, NF 101-1 may utilize KEM techniques to encapsulate the second combination scheme and/or hybrid key 901 when providing such information to NF 101-2. Encapsulating the information may include using some or all of the public keys of NF 101-2 (e.g., Pub_A2 and/or Pub_B2). In accordance with some implementations, the public keys of NF 101-2 may be associated with respective private keys (e.g., Priv_A2 and Priv_B2, respectively), which NF 101-2 may use (at 908) to decapsulate and/or extract the second combination scheme (or hybrid key 901). NF 101-2 may utilize the second combination scheme to generate (at 910) hybrid key 901. In this manner, both NFs 101-1 and 101-2 may have access to both hybrid keys 801 and 901.

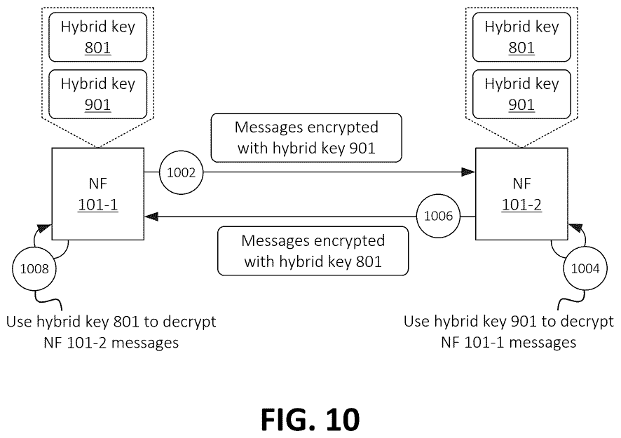

In some embodiments, NF 101-1 may utilize one of hybrid keys 801 or 901 when sending communications to NF 101-2, and NF 101-2 may utilize the other one of hybrid keys 801 or 901 when sending communications to NF 101-1. For example, as shown in FIG. 10, NF 101-1 may output (at 1002) one or more messages to NF 101-2, which have been encrypted using hybrid key 901. NF 101-2 may use hybrid key 901 to decrypt (at 1004) the messages sent by NF 101-1. Similarly, NF 101-2 may output (at 1006) one or more messages to NF 101-1, which have been encrypted using hybrid key 801. NF 101-1 may use hybrid key 801 to decrypt (at 1008) the messages sent by NF 101-2.

While examples are described above with respect to the generation and/or use of hybrid keys (e.g., where such hybrid keys are generated based on keys that are generated in accordance with multiple cryptography techniques), in practice, other examples or variations of generating or using hybrid keys may be implemented in accordance with some embodiments. Further, as noted above with respect to FIG. 1, COS 109 may generate (e.g., using AI/ML techniques or other suitable automated techniques) new cryptography configurations (e.g., cryptography configurations 401) on an ongoing basis, in order to keep the security of NFs 101 up-to-date in view of new threats that may arise as time progresses. For example, COS 109 may generate a first cryptography configuration 401 that indicates the techniques illustrated in FIG. 5, then may subsequently generate or identify a second cryptography configuration 401 that indicates the techniques illustrated in FIG. 7, then may subsequently generate or identify a second cryptography configuration 401 that indicates the techniques illustrated in FIG. 8, and so on. Accordingly, during a first timeframe, NFs 101-1 and 101-2 may implement the first cryptography configuration 401; during a second timeframe, NFs 101-1 and 101-2 may implement the second cryptography configuration 401; during a third timeframe, NFs 101-1 and 101-2 may implement the third cryptography configuration 401; and so on. In this sense, the cryptography configurations implemented by NFs 101 of the network may be “agile” inasmuch as they may be changed or switched with minimal configuration or time overhead.

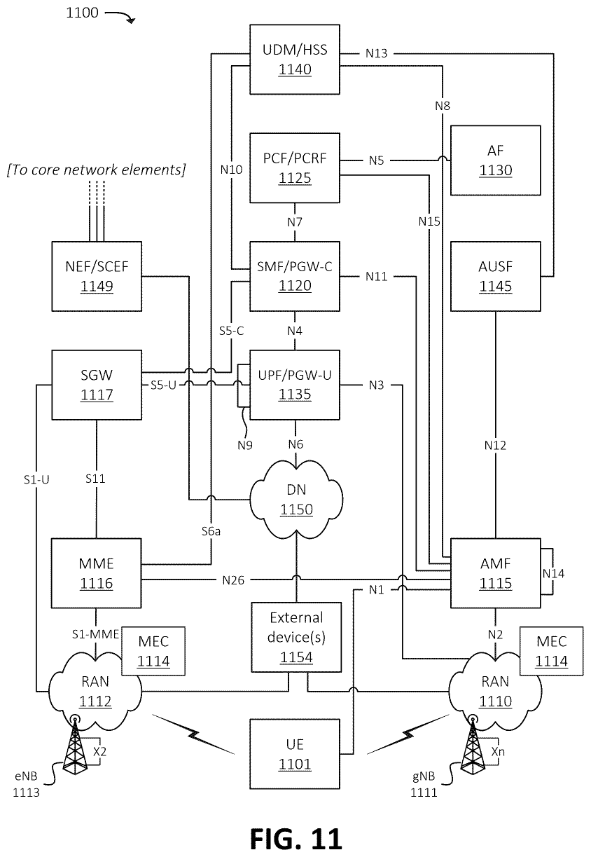

FIG. 11 illustrates an example environment 1100, in which one or more embodiments may be implemented. In some embodiments, environment 1100 may correspond to a Fifth Generation (“5G”) network, and/or may include elements of a 5G network. In some embodiments, environment 1100 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 1100 may represent or may include a 5G core (“5GC”). As shown, environment 1100 may include UE 1101, RAN 1110 (which may include one or more Next Generation Node Bs (“gNBs”) 1111), RAN 1112 (which may include one or more evolved Node Bs (“eNBs”) 1113), and various network functions such as Access and Mobility Management Function (“AMF”) 1115, Mobility Management Entity (“MME”) 1116, Serving Gateway (“SGW”) 1117, Session Management Function (“SMF”)/Packet Data Network (“PDN”) Gateway (“PGW”)-Control plane function (“PGW-C”) 1120, Policy Control Function (“PCF”)/Policy Charging and Rules Function (“PCRF”) 1125, Application Function (“AF”) 1130, User Plane Function (“UPF”)/PGW-User plane function (“PGW-U”) 1135, Unified Data Management (“UDM”)/Home Subscriber Server (“HSS”) 1140, Authentication Server Function (“AUSF”) 1145, and Network Exposure Function (“NEF”)/Service Capability Exposure Function (“SCEF”) 1149. Environment 1100 may also include one or more networks, such as Data Network (“DN”) 1150. Environment 1100 may include one or more additional devices or systems communicatively coupled to one or more networks (e.g., DN 1150), such as one or more external devices 1154.

The example shown in FIG. 11 illustrates one instance of each network component or function (e.g., one instance of SMF/PGW-C 1120, PCF/PCRF 1125, UPF/PGW-U 1135, UDM/HSS 1140, and/or AUSF 1145). In practice, environment 1100 may include multiple instances of such components or functions. For example, in some embodiments, environment 1100 may include multiple “slices” of a core network, where each slice includes a discrete and/or logical set of network functions (e.g., one slice may include a first instance of AMF 1115, SMF/PGW-C 1120, PCF/PCRF 1125, and/or UPF/PGW-U 1135, while another slice may include a second instance of AMF 1115, SMF/PGW-C 1120, PCF/PCRF 1125, and/or UPF/PGW-U 1135). The different slices may provide differentiated levels of service, such as service in accordance with different Quality of Service (“QoS”) parameters.

The quantity of devices and/or networks, illustrated in FIG. 11, is provided for explanatory purposes only. In practice, environment 1100 may include additional devices and/or networks, fewer devices and/or networks, different devices and/or networks, or differently arranged devices and/or networks than illustrated in FIG. 11. For example, while not shown, environment 1100 may include devices that facilitate or enable communication between various components shown in environment 1100, such as routers, modems, gateways, switches, hubs, etc. In some implementations, one or more devices of environment 1100 may be physically integrated in, and/or may be physically attached to, one or more other devices of environment 1100. Alternatively, or additionally, one or more of the devices of environment 1100 may perform one or more network functions described as being performed by another one or more of the devices of environment 1100.

Additionally, one or more elements of environment 1100 may be implemented in a virtualized and/or containerized manner. For example, one or more of the elements of environment 1100 may be implemented by one or more Virtualized Network Functions (“VNFs”), Cloud-Native Network Functions (“CNFs”), etc. In such embodiments, environment 1100 may include, may implement, and/or may be communicatively coupled to an orchestration platform that provisions hardware resources, installs containers or applications, performs load balancing, and/or otherwise manages the deployment of such elements of environment 1100. In some embodiments, such orchestration and/or management of such elements of environment 1100 may be performed by, or in conjunction with, the open-source Kubernetes® application programming interface (“API”) or some other suitable virtualization, containerization, and/or orchestration system.

Elements of environment 1100 may interconnect with each other and/or other devices via wired connections, wireless connections, or a combination of wired and wireless connections. Examples of interfaces or communication pathways between the elements of environment 1100, as shown in FIG. 11, may include an N1 interface, an N2 interface, an N3 interface, an N4 interface, an N5 interface, an N6 interface, an N7 interface, an N8 interface, an N9 interface, an N10 interface, an N11 interface, an N12 interface, an N13 interface, an N14 interface, an N15 interface, an N26 interface, an S1-C interface, an S1-U interface, an S5-C interface, an S5-U interface, an S6a interface, an S11 interface, and/or one or more other interfaces. Such interfaces may include interfaces not explicitly shown in FIG. 11, such as Service-Based Interfaces (“SBIs”), including an Namf interface, an Nudm interface, an Npcf interface, an Nupf interface, an Nnef interface, an Nsmf interface, and/or one or more other SBIs. In some embodiments, one or more elements of environment 1100 may be, may include, may be implemented by, and/or may be communicatively coupled to one or more respective NFs 101.

UE 1101 may include a computation and communication device, such as a wireless mobile communication device that is capable of communicating with RAN 1110, RAN 1112, and/or DN 1150. UE 1101 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a programmable logic controller or other industrial controller, a Machine-to-Machine (“M2M”) device, or the like), a Fixed Wireless Access (“FWA”) device, or another type of mobile computation and communication device. UE 1101 may send traffic to and/or receive traffic (e.g., user plane traffic) from DN 1150 via RAN 1110, RAN 1112, and/or UPF/PGW-U 1135.

RAN 1110 may be, or may include, a 5G RAN that implements a 5G RAT and that includes one or more base stations (e.g., one or more gNBs 1111), via which UE 1101 may communicate with one or more other elements of environment 1100. UE 1101 may communicate with RAN 1110 via an air interface (e.g., as provided by gNB 1111). For instance, RAN 1110 may receive traffic (e.g., user plane traffic such as voice call traffic, data traffic, messaging traffic, etc.) from UE 1101 via the air interface, and may communicate the traffic to UPF/PGW-U 1135 and/or one or more other devices or networks. Further, RAN 1110 may receive signaling traffic, control plane traffic, etc. from UE 1101 via the air interface, and may communicate such signaling traffic, control plane traffic, etc. to AMF 1115 and/or one or more other devices or networks. Additionally, RAN 1110 may receive traffic intended for UE 1101 (e.g., from UPF/PGW-U 1135, AMF 1115, and/or one or more other devices or networks) and may communicate the traffic to UE 1101 via the air interface.

RAN 1112 may be, or may include, an LTE RAN that implements an LTE RAT and that includes one or more base stations (e.g., one or more eNBs 1113), via which UE 1101 may communicate with one or more other elements of environment 1100. UE 1101 may communicate with RAN 1112 via an air interface (e.g., as provided by eNB 1113). For instance, RAN 1112 may receive traffic (e.g., user plane traffic such as voice call traffic, data traffic, messaging traffic, signaling traffic, etc.) from UE 1101 via the air interface, and may communicate the traffic to UPF/PGW-U 1135 (e.g., via SGW 1117) and/or one or more other devices or networks. Further, RAN 1112 may receive signaling traffic, control plane traffic, etc. from UE 1101 via the air interface, and may communicate such signaling traffic, control plane traffic, etc. to MME 1116 and/or one or more other devices or networks. Additionally, RAN 1112 may receive traffic intended for UE 1101 (e.g., from UPF/PGW-U 1135, MME 1116, SGW 1117, and/or one or more other devices or networks) and may communicate the traffic to UE 1101 via the air interface.

One or more RANs of environment 1100 (e.g., RAN 1110 and/or RAN 1112) may include, may implement, and/or may otherwise be communicatively coupled to one or more edge computing devices, such as one or more Multi-Access/Mobile Edge Computing (“MEC”) devices (referred to sometimes herein simply as a “MECs”) 1114. MECs 1114 may be co-located with wireless network infrastructure equipment of RANs 1110 and/or 1112 (e.g., one or more gNBs 1111 and/or one or more eNBs 1113, respectively). Additionally, or alternatively, MECs 1114 may otherwise be associated with geographical regions (e.g., coverage areas) of wireless network infrastructure equipment of RANs 1110 and/or 1112. In some embodiments, one or more MECs 1114 may be implemented by the same set of hardware resources, the same set of devices, etc. that implement wireless network infrastructure equipment of RANs 1110 and/or 1112. In some embodiments, one or more MECs 1114 may be implemented by different hardware resources, a different set of devices, etc. from hardware resources or devices that implement wireless network infrastructure equipment of RANs 1110 and/or 1112. In some embodiments, MECs 1114 may be communicatively coupled to wireless network infrastructure equipment of RANs 1110 and/or 1112 (e.g., via a high-speed and/or low-latency link such as a physical wired interface, a high-speed and/or low-latency wireless interface, or some other suitable communication pathway).

MECs 1114 may include hardware resources (e.g., configurable or provisionable hardware resources) that may be configured to provide services and/or otherwise process traffic to and/or from UE 1101, via RAN 1110 and/or 1112. For example, RAN 1110 and/or 1112 may route some traffic from UE 1101 (e.g., traffic associated with one or more particular services, applications, application types, etc.) to a respective MEC 1114 instead of to core network elements of 1100 (e.g., UPF/PGW-U 1135). MEC 1114 may accordingly provide services to UE 1101 by processing such traffic, performing one or more computations based on the received traffic, and providing traffic to UE 1101 via RAN 1110 and/or 1112. MEC 1114 may include, and/or may implement, some or all of the functionality described above with respect to UPF/PGW-U 1135, AF 1130, one or more application servers, and/or one or more other devices, systems, VNFs, CNFs, etc. In this manner, ultra-low latency services may be provided to UE 1101, as traffic does not need to traverse links (e.g., backhaul links) between RAN 1110 and/or 1112 and the core network.

AMF 1115 may include one or more devices, systems, VNFs, CNFs, etc., that perform operations to register UE 1101 with the 5G network, to establish bearer channels associated with a session with UE 1101, to hand off UE 1101 from the 5G network to another network, to hand off UE 1101 from the other network to the 5G network, manage mobility of UE 1101 between RANs 1110 and/or gNBs 1111, and/or to perform other operations. In some embodiments, the 5G network may include multiple AMFs 1115, which communicate with each other via the N14 interface (denoted in FIG. 11 by the line marked “N14” originating and terminating at AMF 1115).

MME 1116 may include one or more devices, systems, VNFs, CNFs, etc., that perform operations to register UE 1101 with the EPC, to establish bearer channels associated with a session with UE 1101, to hand off UE 1101 from the EPC to another network, to hand off UE 1101 from another network to the EPC, manage mobility of UE 1101 between RANs 1112 and/or eNBs 1113, and/or to perform other operations.

SGW 1117 may include one or more devices, systems, VNFs, CNFs, etc., that aggregate traffic received from one or more eNBs 1113 and send the aggregated traffic to an external network or device via UPF/PGW-U 1135. Additionally, SGW 1117 may aggregate traffic received from one or more UPF/PGW-Us 1135 and may send the aggregated traffic to one or more eNBs 1113. SGW 1117 may operate as an anchor for the user plane during inter-eNB handovers and as an anchor for mobility between different telecommunication networks or RANs (e.g., RANs 1110 and 1112).

SMF/PGW-C 1120 may include one or more devices, systems, VNFs, CNFs, etc., that gather, process, store, and/or provide information in a manner described herein. SMF/PGW-C 1120 may, for example, facilitate the establishment of communication sessions on behalf of UE 1101. In some embodiments, the establishment of communications sessions may be performed in accordance with one or more policies provided by PCF/PCRF 1125.

PCF/PCRF 1125 may include one or more devices, systems, VNFs, CNFs, etc., that aggregate information to and from the 5G network and/or other sources. PCF/PCRF 1125 may receive information regarding policies and/or subscriptions from one or more sources, such as subscriber databases and/or from one or more users (such as, for example, an administrator associated with PCF/PCRF 1125).

AF 1130 may include one or more devices, systems, VNFs, CNFs, etc., that receive, store, and/or provide information that may be used in determining parameters (e.g., quality of service parameters, charging parameters, or the like) for certain applications.

UPF/PGW-U 1135 may include one or more devices, systems, VNFs, CNFs, etc., that receive, store, and/or provide data (e.g., user plane data). For example, UPF/PGW-U 1135 may receive user plane data (e.g., voice call traffic, data traffic, etc.), destined for UE 1101, from DN 1150, and may forward the user plane data toward UE 1101 (e.g., via RAN 1110, SMF/PGW-C 1120, and/or one or more other devices). In some embodiments, multiple instances of UPF/PGW-U 1135 may be deployed (e.g., in different geographical locations), and the delivery of content to UE 1101 may be coordinated via the N9 interface (e.g., as denoted in FIG. 11 by the line marked “N9” originating and terminating at UPF/PGW-U 1135). Similarly, UPF/PGW-U 1135 may receive traffic from UE 1101 (e.g., via RAN 1110, RAN 1112, SMF/PGW-C 1120, and/or one or more other devices), and may forward the traffic toward DN 1150. In some embodiments, UPF/PGW-U 1135 may communicate (e.g., via the N4 interface) with SMF/PGW-C 1120, regarding user plane data processed by UPF/PGW-U 1135.

UDM/HSS 1140 and AUSF 1145 may include one or more devices, systems, VNFs, CNFs, etc., that manage, update, and/or store, in one or more memory devices associated with AUSF 1145 and/or UDM/HSS 1140, profile information associated with a subscriber. In some embodiments, UDM/HSS 1140 may include, may implement, may be communicatively coupled to, and/or may otherwise be associated with some other type of repository or database, such as a Unified Data Repository (“UDR”). AUSF 1145 and/or UDM/HSS 1140 may perform authentication, authorization, and/or accounting operations associated with one or more UEs 1101 and/or one or more communication sessions associated with one or more UEs 1101.

DN 1150 may include one or more wired and/or wireless networks. For example, DN 1150 may include an Internet Protocol (“IP”)-based PDN, a wide area network (“WAN”) such as the Internet, a private enterprise network, and/or one or more other networks. UE 1101 may communicate, through DN 1150, with data servers, other UEs 1101, and/or to other servers or applications that are coupled to DN 1150. DN 1150 may be connected to one or more other networks, such as a public switched telephone network (“PSTN”), a public land mobile network (“PLMN”), and/or another network. DN 1150 may be connected to one or more devices, such as content providers, applications, web servers, and/or other devices, with which UE 1101 may communicate.

External devices 1154 may include one or more devices or systems that communicate with UE 1101 via DN 1150 and one or more elements of 1100 (e.g., via UPF/PGW-U 1135). In some embodiments, external devices 1154 may include, may implement, and/or may otherwise be associated with NMS 103, CAS 105, and/or COS 109. External devices 1154 may include, for example, one or more application servers, content provider systems, web servers, or the like. External devices 1154 may, for example, implement “server-side” applications that communicate with “client-side” applications executed by UE 1101. External devices 1154 may provide services to UE 1101 such as gaming services, videoconferencing services, messaging services, email services, web services, and/or other types of services.

In some embodiments, external devices 1154 may communicate with one or more elements of environment 1100 (e.g., core network elements) via NEF/SCEF 1149. NEF/SCEF 1149 include one or more devices, systems, VNFs, CNFs, etc. that provide access to information, APIs, and/or other operations or mechanisms of one or more core network elements to devices or systems that are external to the core network (e.g., to external device 1154 via DN 1150). NEF/SCEF 1149 may maintain authorization and/or authentication information associated with such external devices or systems, such that NEF/SCEF 1149 is able to provide information, that is authorized to be provided, to the external devices or systems. For example, a given external device 1154 may request particular information associated with one or more core network elements. NEF/SCEF 1149 may authenticate the request and/or otherwise verify that external device 1154 is authorized to receive the information, and may request, obtain, or otherwise receive the information from the one or more core network elements. In some embodiments, NEF/SCEF 1149 may include, may implement, may be implemented by, may be communicatively coupled to, and/or may otherwise be associated with a Security Edge Protection Proxy (“SEPP”), which may perform some or all of the functions discussed above. External device 1154 may, in some situations, subscribe to particular types of requested information provided by the one or more core network elements, and the one or more core network elements may provide (e.g., “push”) the requested information to NEF/SCEF 1149 (e.g., in a periodic or otherwise ongoing basis).

In some embodiments, external devices 1154 may communicate with one or more elements of RAN 1110 and/or 1112 via an API or other suitable interface. For example, a given external device 1154 may provide instructions, requests, etc. to RAN 1110 and/or 1112 to provide one or more services via one or more respective MECs 1114. In some embodiments, such instructions, requests, etc. may include QoS parameters, Service Level Agreements (“SLAs”), etc. (e.g., maximum latency thresholds, minimum throughput thresholds, etc.) associated with the services.

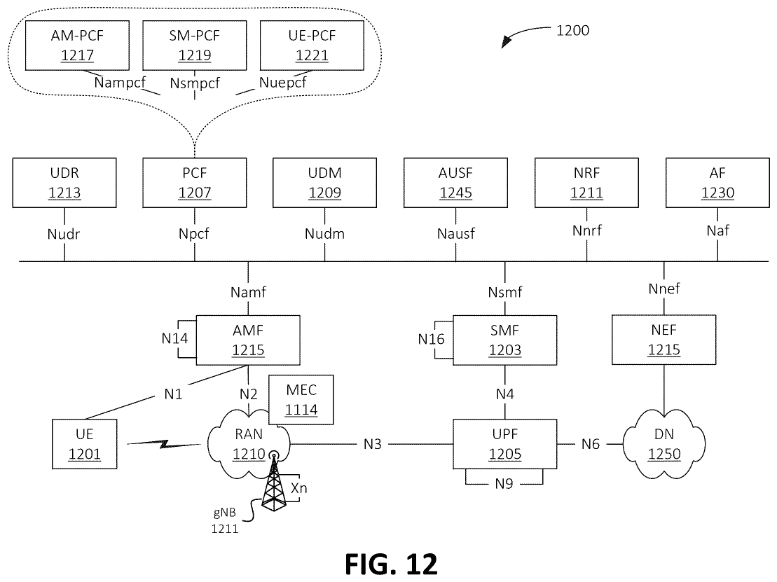

FIG. 12 illustrates another example environment 1200, in which one or more embodiments may be implemented. In some embodiments, environment 1200 may correspond to a 5G network, and/or may include elements of a 5G network. In some embodiments, environment 1200 may correspond to a 5G SA architecture. In some embodiments, environment 1200 may include a 5GC, in which 5GC network elements perform one or more operations described herein.

As shown, environment 1200 may include UE 1101, RAN 1110 (which may include one or more gNBs 1111 or other types of wireless network infrastructure) and various network functions, which may be implemented as VNFs, CNFs, etc. Such network functions may include AMF 1115, SMF 1203, UPF 1205, PCF 1207, UDM 1209, AUSF 1145, Network Repository Function (“NRF”) 1211, AF 1130, UDR 1213, and NEF 1215. Environment 1200 may also include or may be communicatively coupled to one or more networks, such as DN 1150.

The example shown in FIG. 12 illustrates one instance of each network component or function (e.g., one instance of SMF 1203, UPF 1205, PCF 1207, UDM 1209, AUSF 1145, etc.). In practice, environment 1200 may include multiple instances of such components or functions. For example, in some embodiments, environment 1200 may include multiple “slices” of a core network, where each slice includes a discrete and/or logical set of network functions (e.g., one slice may include a first instance of SMF 1203, PCF 1207, UPF 1205, etc., while another slice may include a second instance of SMF 1203, PCF 1207, UPF 1205, etc.). Additionally, or alternatively, one or more of the network functions of environment 1200 may implement multiple network slices. The different slices may provide differentiated levels of service, such as service in accordance with different QoS parameters.

The quantity of devices and/or networks, illustrated in FIG. 12, is provided for explanatory purposes only. In practice, environment 1200 may include additional devices and/or networks, fewer devices and/or networks, different devices and/or networks, or differently arranged devices and/or networks than illustrated in FIG. 12. For example, while not shown, environment 1200 may include devices that facilitate or enable communication between various components shown in environment 1200, such as routers, modems, gateways, switches, hubs, etc. In some implementations, one or more devices of environment 1200 may be physically integrated in, and/or may be physically attached to, one or more other devices of environment 1200. Alternatively, or additionally, one or more of the devices of environment 1200 may perform one or more network functions described as being performed by another one or more of the devices of environment 1200.

Elements of environment 1200 may interconnect with each other and/or other devices via wired connections, wireless connections, or a combination of wired and wireless connections. Examples of interfaces or communication pathways between the elements of environment 1200, as shown in FIG. 12, may include interfaces shown in FIG. 12 and/or one or more interfaces not explicitly shown in FIG. 12. These interfaces may include interfaces between specific network functions, such as an N1 interface, an N2 interface, an N3 interface, an N6 interface, an N9 interface, an N14 interface, an N16 interface, and/or one or more other interfaces. In some embodiments, one or more elements of environment 1200 may communicate via a service-based architecture (“SBA”), in which a routing mesh or other suitable routing mechanism may route communications to particular network functions based on interfaces or identifiers associated with such network functions. Such interfaces may include or may be referred to as SBIs, including an Namf interface (e.g., indicating communications to be routed to AMF 1115), an Nudm interface (e.g., indicating communications to be routed to UDM 1209), an Npcf interface, an Nupf interface, an Nnef interface, an Nsmf interface, an Nnrf interface, an Nudr interface, an Naf interface, and/or one or more other SBIs. In some embodiments, one or more elements of environment 1200 may be, may include, may be implemented by, and/or may be communicatively coupled to one or more respective NFs 101.

UPF 1205 may include one or more devices, systems, VNFs, CNFs, etc., that receive, route, process, and/or forward traffic (e.g., user plane traffic). As discussed above, UPF 1205 may communicate with UE 1101 via one or more communication sessions, such as PDU sessions. Such PDU sessions may be associated with a particular network slice or other suitable QoS parameters, as noted above. UPF 1205 may receive downlink user plane traffic (e.g., voice call traffic, data traffic, etc. destined for UE 1101) from DN 1150, and may forward the downlink user plane traffic toward UE 1101 (e.g., via RAN 1110). In some embodiments, multiple UPFs 1205 may be deployed (e.g., in different geographical locations), and the delivery of content to UE 1101 may be coordinated via the N9 interface. Similarly, UPF 1205 may receive uplink traffic from UE 1101 (e.g., via RAN 1110), and may forward the traffic toward DN 1150. In some embodiments, UPF 1205 may implement, may be implemented by, may be communicatively coupled to, and/or may otherwise be associated with UPF/PGW-U 1135. In some embodiments, UPF 1205 may communicate (e.g., via the N4 interface) with SMF 1203, regarding user plane data processed by UPF 1205 (e.g., to provide analytics or reporting information, to receive policy and/or authorization information, etc.).

PCF 1207 may include one or more devices, systems, VNFs, CNFs, etc., that aggregate, derive, generate, etc. policy information associated with the 5GC and/or UEs 1101 that communicate via the 5GC and/or RAN 1110. PCF 1207 may receive information regarding policies and/or subscriptions from one or more sources, such as subscriber databases (e.g., UDM 1209, UDR 1213, etc.), and/or from one or more users such as, for example, an administrator associated with PCF 1207. In some embodiments, the functionality of PCF 1207 may be split into multiple network functions or subsystems, such as access and mobility PCF (“AM-PCF”) 1217, session management PCF (“SM-PCF”) 1219, UE PCF (“UE-PCF”) 1221, and so on. Such different “split” PCFs may be associated with respective SBIs (e.g., AM-PCF 1217 may be associated with an Nampcf SBI, SM-PCF 1219 may be associated with an Nsmpcf SBI, UE-PCF 1221 may be associated with an Nuepcf SBI, and so on) via which other network functions may communicate with the split PCFs. The split PCFs may maintain information regarding policies associated with different devices, systems, and/or network functions.

NRF 1211 may include one or more devices, systems, VNFs, CNFs, etc. that maintain routing and/or network topology information associated with the 5GC. For example, NRF 1211 may maintain and/or provide IP addresses of one or more network functions, routes associated with one or more network functions, discovery and/or mapping information associated with particular network functions or network function instances (e.g., whereby such discovery and/or mapping information may facilitate the SBA), and/or other suitable information.

UDR 1213 may include one or more devices, systems, VNFs, CNFs, etc. that provide user and/or subscriber information, based on which PCF 1207 and/or other elements of environment 1200 may determine access policies, QoS policies, charging policies, or the like. In some embodiments, UDR 1213 may receive such information from UDM 1209 and/or one or more other sources.

NEF 1215 include one or more devices, systems, VNFs, CNFs, etc. that provide access to information, APIs, and/or other operations or mechanisms of the 5GC to devices or systems that are external to the 5GC. NEF 1215 may maintain authorization and/or authentication information associated with such external devices or systems, such that NEF 1215 is able to provide information, that is authorized to be provided, to the external devices or systems. Such information may be received from other network functions of the 5GC (e.g., as authorized by an administrator or other suitable entity associated with the 5GC), such as SMF 1203, UPF 1205, a charging function (“CHF”) of the 5GC, and/or other suitable network function. NEF 1215 may communicate with external devices or systems (e.g., external devices 1154) via DN 1150 and/or other suitable communication pathways.

While environment 1200 is described in the context of a 5GC, as noted above, environment 1200 may, in some embodiments, include or implement one or more other types of core networks. For example, in some embodiments, environment 1200 may be or may include a converged packet core, in which one or more elements may perform some or all of the functionality of one or more 5GC network functions and/or one or more EPC network functions. For example, in some embodiments, AMF 1115 may include, may implement, may be implemented by, and/or may otherwise be associated with MME 1116; SMF 1203 may include, may implement, may be implemented by, and/or may otherwise be associated with SGW 1117; PCF 1207 may include, may implement, may be implemented by, and/or may otherwise be associated with a PCRF (e.g., PCF/PCRF 1125); NEF 1215 may include, may implement, may be implemented by, and/or may otherwise be associated with a SCEF (e.g., NEF/SCEF 1149); and so on.

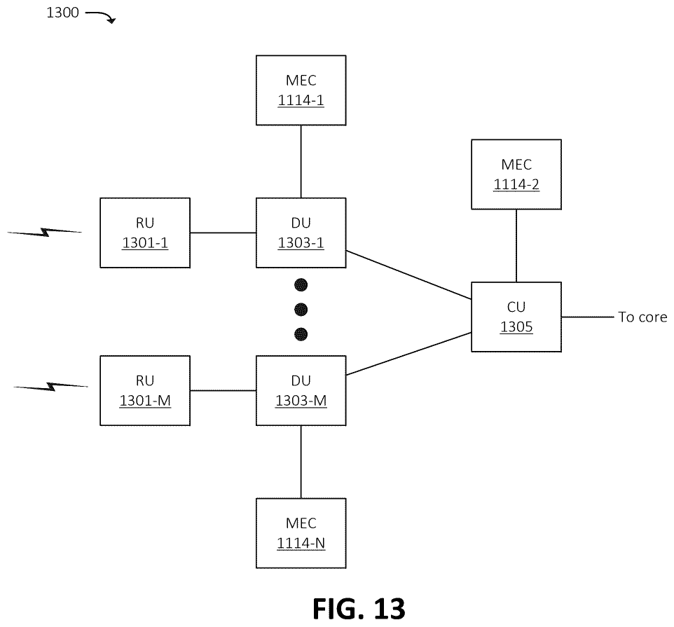

FIG. 13 illustrates an example RAN environment 1300, which may be included in and/or implemented by one or more RANs (e.g., RAN 1110 or some other RAN). In some embodiments, a particular RAN 1110 may include one RAN environment 1300. In some embodiments, a particular RAN 1110 may include multiple RAN environments 1300. In some embodiments, RAN environment 1300 may correspond to a particular gNB 1111 of RAN 1110. In some embodiments, RAN environment 1300 may correspond to multiple gNBs 1111. In some embodiments, RAN environment 1300 may correspond to one or more other types of base stations of one or more other types of RANs. As shown, RAN environment 1300 may include Central Unit (“CU”) 1305, one or more Distributed Units (“DUs”) 1303-1 through 1303-M (referred to individually as “DU 1303,” or collectively as “DUs 1303”), and one or more Radio Units (“RUs”) 1301-1 through 1301-M (referred to individually as “RU 1301,” or collectively as “RUs 1301”).

CU 1305 may communicate with a core of a wireless network (e.g., may communicate with one or more of the devices or systems described above with respect to FIG. 12, such as AMF 1115 and/or UPF 1205) and/or some other device or system such as MEC 1114. In the uplink direction (e.g., for traffic from UEs 1101 to a core network), CU 1305 may aggregate traffic from DUs 1303, and forward the aggregated traffic to the core network. In some embodiments, CU 1305 may receive traffic according to a given protocol (e.g., Radio Link Control (“RLC”) traffic) from DUs 1303, and may perform higher-layer processing (e.g., may aggregate/process RLC packets and generate Packet Data Convergence Protocol (“PDCP”) packets based on the RLC packets) on the traffic received from DUs 1303.

CU 1305 may receive downlink traffic (e.g., traffic from the core network, traffic from a given MEC 1114, etc.) for a particular UE 1101, and may determine which DU(s) 1303 should receive the downlink traffic. DU 1303 may include one or more devices that transmit traffic between a core network (e.g., via CU 1305) and UE 1101 (e.g., via a respective RU 1301). DU 1303 may, for example, receive traffic from RU 1301 at a first layer (e.g., physical (“PHY”) layer traffic, or lower PHY layer traffic), and may process/aggregate the traffic to a second layer (e.g., upper PHY and/or RLC). DU 1303 may receive traffic from CU 1305 at the second layer, may process the traffic to the first layer, and provide the processed traffic to a respective RU 1301 for transmission to UE 1101.

RU 1301 may include hardware circuitry (e.g., one or more RF transceivers, antennas, radios, and/or other suitable hardware) to communicate wirelessly (e.g., via an RF interface) with one or more UEs 1101, one or more other DUs 1303 (e.g., via RUs 1301 associated with DUs 1303), and/or any other suitable type of device. In the uplink direction, RU 1301 may receive traffic from UE 1101 and/or another DU 1303 via the RF interface and may provide the traffic to DU 1303. In the downlink direction, RU 1301 may receive traffic from DU 1303, and may provide the traffic to UE 1101 and/or another DU 1303.

One or more elements of RAN environment 1300 may, in some embodiments, be communicatively coupled to one or more MECs 1114. For example, DU 1303-1 may be communicatively coupled to MEC 1114-1, DU 1303-M may be communicatively coupled to MEC 1114-N, CU 1305 may be communicatively coupled to MEC 1114-2, and so on. MECs 1114 may include hardware resources (e.g., configurable or provisionable hardware resources) that may be configured to provide services and/or otherwise process traffic to and/or from UE 1101, via a respective RU 1301.

For example, DU 1303-1 may route some traffic, from UE 1101, to MEC 1114-1 instead of to a core network via CU 1305. MEC 1114-1 may process the traffic, perform one or more computations based on the received traffic, and may provide traffic to UE 1101 via RU 1301-1. As discussed above, MEC 1114 may include, and/or may implement, some or all of the functionality described above with respect to UPF 1205, AF 1130, and/or one or more other devices, systems, VNFs, CNFs, etc. In this manner, ultra-low latency services may be provided to UE 1101, as traffic does not need to traverse DU 1303, CU 1305, links between DU 1303 and CU 1305, and an intervening backhaul network between RAN environment 1300 and the core network.

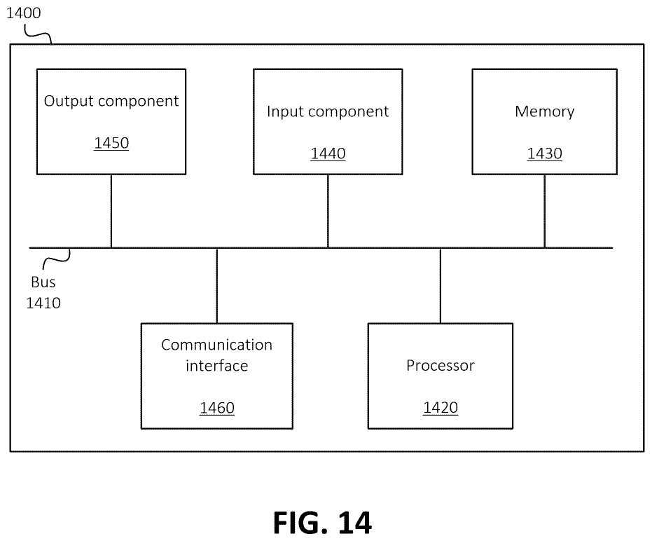

FIG. 14 illustrates example components of device 1400. One or more of the devices described above may include one or more devices 1400. Device 1400 may include bus 1410, processor 1420, memory 1430, input component 1440, output component 1450, and communication interface 1460. In another implementation, device 1400 may include additional, fewer, different, or differently arranged components.

Bus 1410 may include one or more communication paths that permit communication among the components of device 1400. Processor 1420 may include a processor, microprocessor, a set of provisioned hardware resources of a cloud computing system, or other suitable type of hardware that interprets and/or executes instructions (e.g., processor-executable instructions). In some embodiments, processor 1420 may be or may include one or more hardware processors. Memory 1430 may include any type of dynamic storage device that may store information and instructions for execution by processor 1420, and/or any type of non-volatile storage device that may store information for use by processor 1420.

Input component 1440 may include a mechanism that permits an operator to input information to device 1400 and/or other receives or detects input from a source external to input component 1440, such as a touchpad, a touchscreen, a keyboard, a keypad, a button, a switch, a microphone or other audio input component, etc. In some embodiments, input component 1440 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1450 may include a mechanism that outputs information to the operator, such as a display, a speaker, one or more light emitting diodes (“LEDs”), etc.

Communication interface 1460 may include any transceiver-like mechanism that enables device 1400 to communicate with other devices and/or systems (e.g., via RAN 1110, RAN 1112, DN 1150, etc.). For example, communication interface 1460 may include an Ethernet interface, an optical interface, a coaxial interface, or the like. Communication interface 1460 may include a wireless communication device, such as an infrared (“IR”) receiver, a Bluetooth® radio, or the like. The wireless communication device may be coupled to an external device, such as a cellular radio, a remote control, a wireless keyboard, a mobile telephone, etc. In some embodiments, device 1400 may include more than one communication interface 1460. For instance, device 1400 may include an optical interface, a wireless interface, an Ethernet interface, and/or one or more other interfaces.

Device 1400 may perform certain operations relating to one or more processes described above. Device 1400 may perform these operations in response to processor 1420 executing instructions, such as software instructions, processor-executable instructions, etc. stored in a computer-readable medium, such as memory 1430. A computer-readable medium may be defined as a non-transitory memory device. A memory device may include space within a single physical memory device or spread across multiple physical memory devices. The instructions may be read into memory 1430 from another computer-readable medium or from another device. The instructions stored in memory 1430 may be processor-executable instructions that cause processor 1420 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-10), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
maintain a set of models that include a plurality of cryptography configurations, wherein at least a particular cryptography configuration specifies:
a first cryptography technique,
a second cryptography technique, and
a combination scheme; and
provide the particular cryptography configuration to a particular system, wherein the particular system:
generates a first key based on the first cryptography technique,
generates a second key based on the second cryptography technique,
generates a third key based on the first key, the second key, and the combination scheme, and
encrypts one or more communications using the third key.

2. The device of claim 1, wherein the set of models include one or more artificial intelligence/machine learning (“AI/ML”) models.

3. The device of claim 1, wherein the third key is a symmetric key.

4. The device of claim 1, wherein the combination scheme indicates one or more operations to perform with respect to one or more keys generated using the first cryptography technique and one or more keys generated using the second cryptography technique.

5. The device of claim 1, wherein the first key includes a first set of characters, wherein the second key includes a second set of characters, wherein the third key includes a third set of characters that is based on the first and second sets of characters.

6. The device of claim 5, wherein the third set of characters includes an interspersing of one or more characters of the first set of characters with one or more characters of the second set of characters.

7. The device of claim 1, wherein the particular cryptography configuration is a first cryptography configuration, wherein the combination scheme is a first combination scheme, wherein the one or more processors are further configured to:
identify a second cryptography configuration based on the set of models, wherein the second cryptography configuration specifies a second combination scheme that is different from the first combination scheme; and
provide the second cryptography configuration to the particular system, wherein the particular system implements the second cryptography configuration in lieu of the first cryptography configuration based on receiving the second cryptography configuration.

8. A non-transitory computer-readable medium, storing a plurality of processor-executable instructions to:
maintain a set of models that include a plurality of cryptography configurations, wherein at least a particular cryptography configuration specifies:
a first cryptography technique,
a second cryptography technique, and
a combination scheme; and
provide the particular cryptography configuration to a particular system, wherein the particular system:
generates a first key based on the first cryptography technique,
generates a second key based on the second cryptography technique,
generates a third key based on the first key, the second key, and the combination scheme, and
encrypts one or more communications using the third key.

9. The non-transitory computer-readable medium of claim 8, wherein the set of models include one or more artificial intelligence/machine learning (“AI/ML”) models.

10. The non-transitory computer-readable medium of claim 8, wherein the third key is a symmetric key.

11. The non-transitory computer-readable medium of claim 8, wherein the combination scheme indicates one or more operations to perform with respect to one or more keys generated using the first cryptography technique and one or more keys generated using the second cryptography technique.

12. The non-transitory computer-readable medium of claim 8, wherein the first key includes a first set of characters, wherein the second key includes a second set of characters, wherein the third key includes a third set of characters that is based on the first and second sets of characters.

13. The non-transitory computer-readable medium of claim 12, wherein the third set of characters includes an interspersing of one or more characters of the first set of characters with one or more characters of the second set of characters.

14. The non-transitory computer-readable medium of claim 8, wherein the particular cryptography configuration is a first cryptography configuration, wherein the combination scheme is a first combination scheme, wherein the plurality of processor-executable instructions further include processor-executable instructions to:
identify a second cryptography configuration based on the set of models, wherein the second cryptography configuration specifies a second combination scheme that is different from the first combination scheme; and
provide the second cryptography configuration to the particular system, wherein the particular system implements the second cryptography configuration in lieu of the first cryptography configuration based on receiving the second cryptography configuration.

15. A method, comprising:
maintaining a set of models that include a plurality of cryptography configurations, wherein at least a particular cryptography configuration specifies:
a first cryptography technique,
a second cryptography technique, and
a combination scheme; and
providing the particular cryptography configuration to a particular system, wherein the particular system:
generates a first key based on the first cryptography technique,
generates a second key based on the second cryptography technique,
generates a third key based on the first key, the second key, and the combination scheme, and
encrypts one or more communications using the third key.

16. The method of claim 15, wherein the set of models include one or more artificial intelligence/machine learning (“AI/ML”) models.

17. The method of claim 15, wherein the third key is a symmetric key.

18. The method of claim 15, wherein the combination scheme indicates one or more operations to perform with respect to one or more keys generated using the first cryptography technique and one or more keys generated using the second cryptography technique.

19. The method of claim 15, wherein the first key includes a first set of characters, wherein the second key includes a second set of characters, wherein the third key includes a third set of characters that is based on the first and second sets of characters, wherein the third set of characters includes an interspersing of one or more characters of the first set of characters with one or more characters of the second set of characters.

20. The method of claim 15, wherein the particular cryptography configuration is a first cryptography configuration, wherein the combination scheme is a first combination scheme, the method further comprising:
identifying a second cryptography configuration based on the set of models, wherein the second cryptography configuration specifies a second combination scheme that is different from the first combination scheme; and
providing the second cryptography configuration to the particular system, wherein the particular system implements the second cryptography configuration in lieu of the first cryptography configuration based on receiving the second cryptography configuration.
